(19) United States
(12) Patent Application Publication
(10) Pub. No.: US 2013/0266080 A1
(43) Pub. Date: Oct. 10, 2013

(54) SYSTEMS, METHODS AND COMPUTER PROGRAM PRODUCTS FOR INTEGRATED POST-PROCESSING AND PRE-PROCESSING IN VIDEO TRANSCODING

(71) Applicants: Ning Lu, Saratoga, CA (US); Brian D. Rauchfuss, Shingle Springs, CA (US); Sang-Hee Lee, Santa Clara, CA (US); Yi-Jen Chiu, San Jose, CA (US)

(72) Inventors: Ning Lu, Saratoga, CA (US); Brian D. Rauchfuss, Shingle Springs, CA (US); Sang-Hee Lee, Santa Clara, CA (US); Yi-Jen Chiu, San Jose, CA (US)

(21) Appl. No.: 13/994,773

(22) PCT Filed: Oct. 1, 2011
(86) PCT No.: PCT/US11/54470

§ 371 Date: Jun. 17, 2013

(51) Int. Cl. H04N 7/26

(52) U.S. Cl. CPC H04N 19/00909; H04N 19/00472
USPC 375/240.26

(57) ABSTRACT

Methods, systems and computer program products to increase the efficiency of a trancoding system by providing additional data from a video processor to an encoder, and by providing control signals from the encoder back to the video processor. The video processor may provide variances to the encoder, where these values would not otherwise be available to the encoder or would be computationally intensive for the encoder to generate on its own. The encoder may then use these variances to generate encoded, compressed video data more efficiently. The encoder may also generate control signals for use by the video processor, enabling the video processor to adapt to reconfigurations of the encoder, thereby improving the efficiency of the transcoding operation.

### BACKGROUND

In a conventional video transcoding process, there may be three major components: a decoder, a video processor (sometimes called an enhancer), and an encoder. The decoder may receive compressed video data, perform decoding along with other operations such as &blocking and fixing of artifacts, and output raw video. The video processor may accept this raw video and perform a variety of operations, such as deinterlacing, telecine inversion, frame rate conversion, denoising and re-scaling. The output of the video processor may then he sent to an encoder, which may perform additional operations, such as statistical image analysis and pixel-based image analysis, and which may perform the actual encoding. The resulting output is transcoded video data. The encoder and decoder may be viewed as essentially independent components.

There are, however, inefficiencies in this arrangement. If the encoder were to have additional information available to it, the transcoding could proceed more quickly. For example, if an encoder were to know that a current video frame is a repetition of a previous frame due to telecine conversion, then encoding of the current frame could he skipped. The encoder could also adjust the real picture presentation time, leading to more accurate motion prediction.

In addition, video processing variances may be useful to the encoding process, but are not necessarily available to the encoder. The encoder has to generate these variances itself. However, this operation may be computationally intensive for the encoder. For certain variances, such as some types of temporal variances, the encoder may not be able to generate them at all because of hi-predictive frame (B-frame) shuffling.

Moreover, in a conventional architecture the video processor receives no feedback from the encoder. The encoder may have to adjust its configuration due to a bitrate change or an application request, for example, but because the video processor is unaware of these changes in the encoder, the video processor is unable to adapt. For example, if the encoder is reconfigured to increase its level of data compression, the quantization parameter is larger. Ideally, the video processor would increase its level of denoising to adapt to the larger quantization parameter. But in the above architecture, the video processor is unaware of the increased level of data compression and the larger quantization parameter. As a result, the video processor is unable to adapt to the reconfigured encoder, making the overall transcoding process inefficient.

### BRIEF DESCRIPTION OF THE DRAWINGS/FIGURES

FIG. 1 is a block diagram illustrating the operation of a traditional video transcoding system.

FIG. 2 is a block diagram illustrating the operation of a video transcoding system according to an embodiment.

FIG. 3 is a flowchart illustrating the processing of a video transcoding system according to an embodiment.

FIG. 4 is flowchart illustrating control signal generation at an encoder, according to an embodiment.

FIG. 5 is a block diagram illustrating a software or firmware embodiment of a video processor, according to an embodiment.

FIG. 6 is a block diagram illustrating a software or firmware embodiment of an encoder, according to an embodiment,

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods, systems and computer program products to increase the efficiency of a video transcoding system by providing additional data from a video processor to an encoder, and by providing control signals from the encoder back to the video processor. The video processor provides variances to the encoder, where these values would not otherwise be available to the encoder or would be computationally intensive for the encoder to generate on its own. The encoder may then use these variances to generate encoded, compressed video data more efficiently. The encoder may also generate control signals for use by the video processor, enabling the video processor to adapt to reconfigurations of the encoder, thereby improving the efficiency of the transcoding operation.

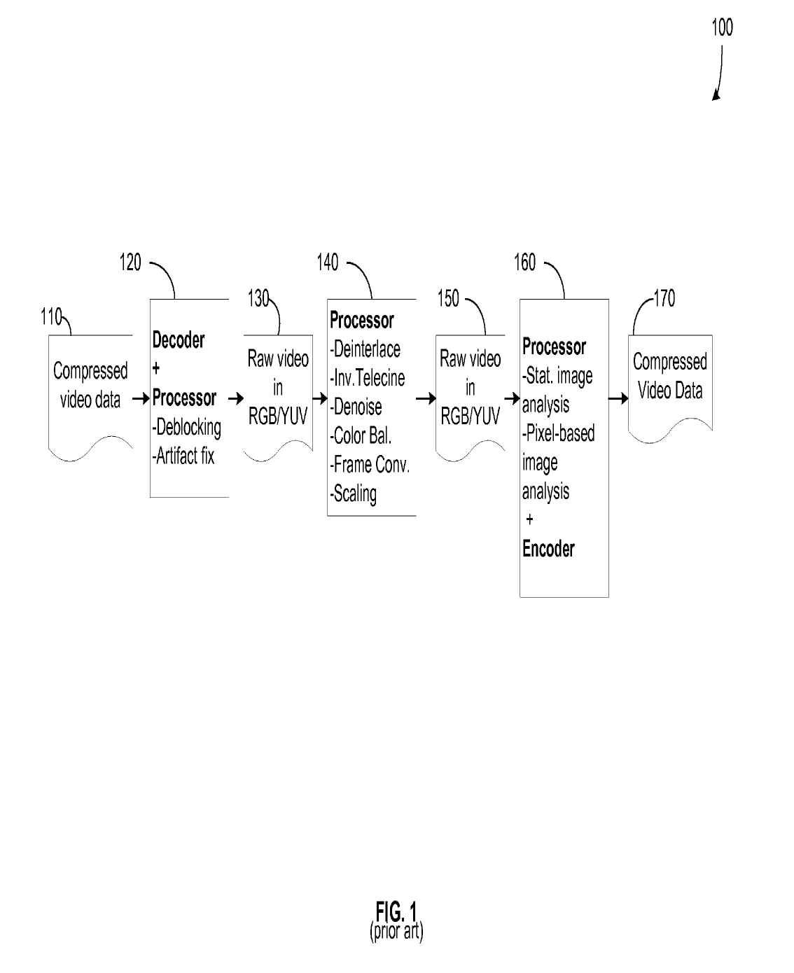

FIG. 1 illustrates a traditional video transcoding system. Compressed video data 110 may be received in the system 100 and input to a decoder 120. In the system shown, decoder 120 includes additional functionality, including deblocking and the fixing of artifacts. Decoder 120 may then output decoded raw video 130 to a video processor 140, sometimes called an enhancer. The video processor 140 may perform a number of functions, some of which are shown. These functions may include deinterlacing, inverse telecine conversion, denoising, color balancing, frame conversion, and scaling. Video processor 140 may then output processed raw video 150. The processed raw video 150 may then be passed to an encoder 160. In the system shown, the encoder 160 includes additional functionality, such as statistical image analysis and pixel-based image analysis. In statistical image analysis, the image analysis may be based on a scan of collected statistics. In pixel-based image analysis, the image analysis may be performed at the pixel level. The final output may be encoded compressed video 170.

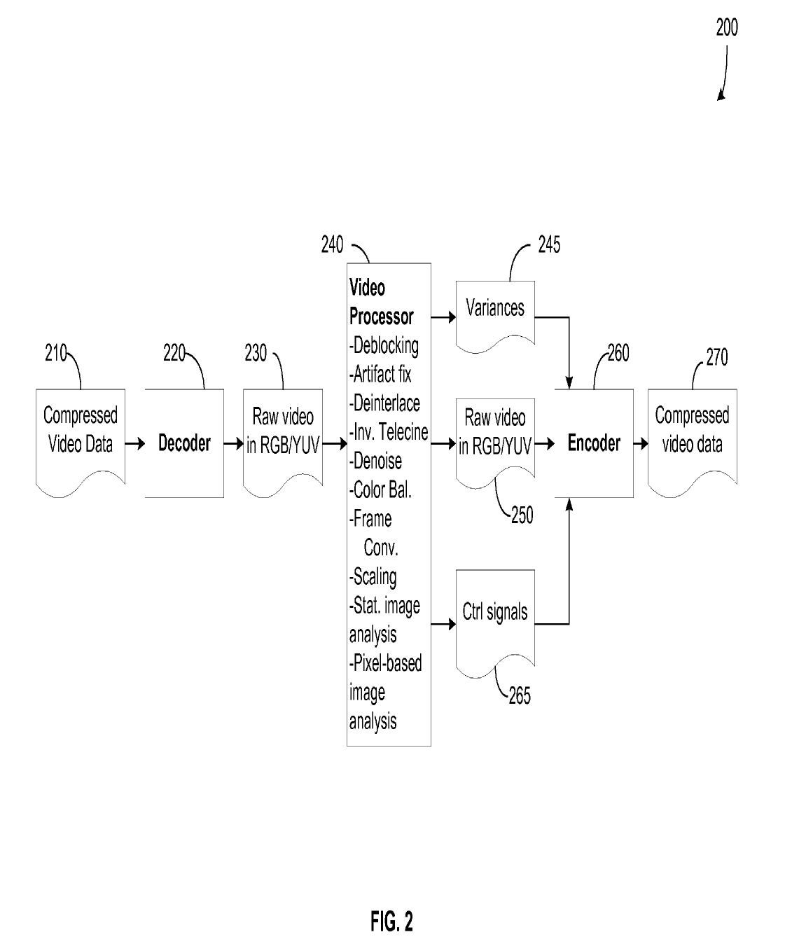

FIG. 2 illustrates a video transcoding system 200 in accordance with an embodiment. Compressed video data 210 may be received by the system 200 and input to a decoder 220. In the system shown, decoder 220 does not include the additional functionality of decoder 120 in FIG. 1. In particular, the deblocking and the fixing of artifacts may be performed in a video processor 240 instead. Decoder 220 may then output decoded raw video 230 to video processor 240. The video processor 240 may perform a number of functions, some of which are shown. These functions may include deinterlacing, inverse telecine conversion, denoising, color balancing, frame conversion, and scaling, as well as artifact fixing and deblocking. In the illustrated embodiment, video processor 240 may also perform statistical image analysis and pixel-based image analysis, functions that were performed by encoder 160 in the system of FIG. 1. Video processor 240 may then output processed raw video 250 to encoder 260.

In the illustrated embodiment, the video processor 240 may also generate one or more variances 245. These may be provided to encoder 260 to facilitate the operation of that component. Examples of variances 245 are provided below. In addition, under certain circumstances, the encoder 260 may have to reconfigure itself. In the embodiment shown, this may result in the formulation of one or more control signals 265 that may be fed back to the video processor 240. Control signals 265 may be used by video processor 240 to initiate adjustments in its processing, so as to adapt to the reconfigured encoder 260. Such reconfiguration of encoder 260 and the use of control signals 265 by the video processor 240 are described in greater detail below. The final output of system 200 may be encoded compressed video 270.

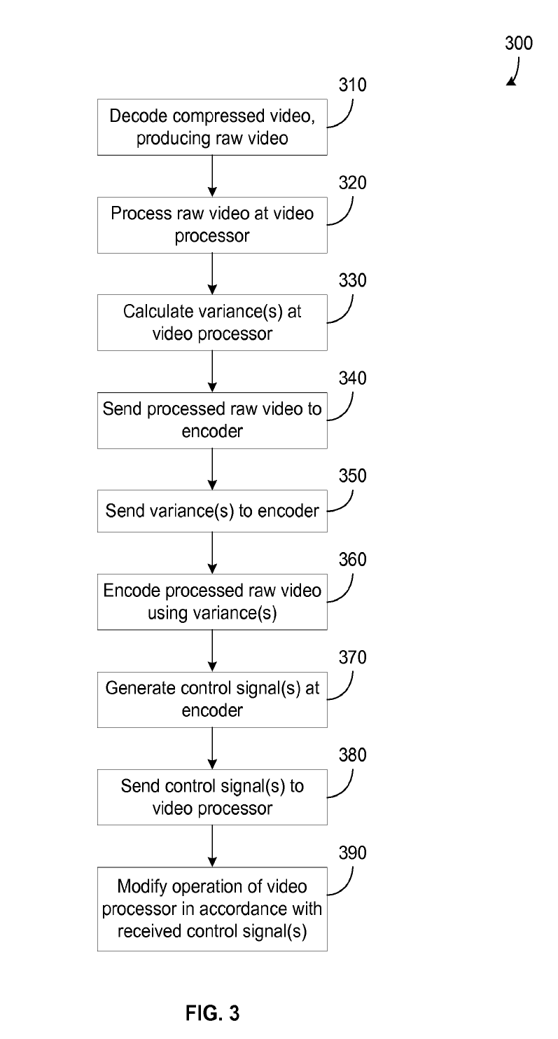

The operation of the system described herein is illustrated in FIG. 3, according to an embodiment. At 310, compressed video data may be decoded by a decoder, yielding raw video data. At 320, the raw video data may be processed at a video processor. As shown in FIG. 2, the video processing may include a number of operations performed on the raw video received from the decoder, including but not limited to artifact fixing, deblocking, denoising, statistical image analysis and pixel-based image analysis, deinterlacing, inverse telecine conversion, color balancing, frame conversion and scaling.

At 330, the video processor may calculate one or more variances. At 340, the processed raw video may be output by the video processor and sent to an encoder. At 350, the video processor may send these variances to the encoder. The variances may be used by an encoder in a number of ways. For example, local variances may be used to narrow down the set of possible macroblock (MB) code types, which may save searching time. This may help to optimize local encoding. Variances may also reflect scene changes or video content switches, for example. Knowing such variances may allow the encoder to derive complexity changes. Variances may also facilitate quantization parameter (QP) adjustments at the encoder, which may allow for a more accurate data size and better rate control.

The following represent variances that may be generated in an embodiment that transcodes interlaced and inverse telecine video. These variances assume that each video frame may consist of two interlaced pictures, a top and a bottom picture. The top picture may have even y-coordinates, and the bottom picture may have odd y-coordinates. Each variance may relate to one or both of two consecutive video frames, a previous frame and a current frame. For any block region of a frame, the top picture may have pixels with (x, y) coordinates of the form (x, 2y). The block may have a width w and a height 2h. The functions prey and curr may output pixel values at the indicated coordinates.

A variance for a previous top picture may calculated as

$$\frac{1}{w ( h - 1 )} {\sum }_{j = 0}^{h - 1} {\sum }_{i = 0}^{w} {\vert prev ( x + i , 2 ( y + j ) ) - prev ( x + i , 2 ( y + j + 1 ) ) \vert}^{p}$$

A variance for a previous bottom picture may calculated as

$$\frac{1}{w ( h - 1 )} {\sum }_{j = 0}^{h - 1} {\sum }_{i = 0}^{w} {\vert prev ( x + i , 2 ( y + j ) + 1 ) - prev ( x + i , 2 ( y + j ) + 3 ) \vert}^{p}$$

A variance for a current top picture may calculated as

$$\frac{1}{w ( h - 1 )} {\sum }_{j = 0}^{h - 1} {\sum }_{i = 0}^{w} {\vert curr ( x + i , 2 ( y + j ) ) - curr ( x + i , 2 ( y + j + 1 ) ) \vert}^{p}$$

A variance for a current bottom picture may calculated as

$$\frac{1}{w ( h - 1 )} {\sum }_{j = 0}^{h - 1} {\sum }_{i = 0}^{w} {\vert curr ( x + i , 2 ( y + j ) + 1 ) - curr ( x + i , 2 ( y + j ) + 3 ) \vert}^{p}$$

A variance between the top pictures may calculated as

$$\frac{1}{w \cdot h} {\sum }_{j = 0}^{h} {\sum }_{i = 0}^{w} {\vert curr ( x + i , 2 ( y + j ) ) - prev ( x + i , 2 ( y + j ) ) \vert}^{p}$$

A variance between the bottom pictures may calculated as

$$\frac{1}{w \cdot h} {\sum }_{j = 0}^{h} {\sum }_{i = 0}^{w} {\vert curr ( x + i , 2 ( y + j ) + 1 ) - prev ( x + i , 2 ( y + j ) + 1 ) \vert}^{p}$$

A variance between the previous top picture and the previous bottom picture may calculated as

$$\frac{1}{w \cdot h} {\sum }_{j = 0}^{h} {\sum }_{i = 0}^{w} {\vert prev ( x + i , 2 ( y + j ) ) - prev ( x + i , 2 ( y + j ) + 1 ) \vert}^{p}$$

A variance between the current top picture and the current bottom picture may calculated as

$$\frac{1}{w \cdot h} {\sum }_{j = 0}^{h} {\sum }_{i = 0}^{w} {\vert curr ( x + i , 2 ( y + j ) ) - curr ( x + i , 2 ( y + j ) + 1 ) \vert}^{p}$$

A variance between the current top picture and the previous bottom picture may calculated as

$$\frac{1}{w \cdot h} {\sum }_{j = 0}^{h} {\sum }_{i = 0}^{w} {\vert curr ( x + i , 2 ( y + j ) ) - prev ( x + i , 2 ( y + j ) + 1 ) \vert}^{p}$$

A variance between the previous top picture and the current bottom picture may calculated as

$$\frac{1}{w \cdot h} {\sum }_{j = 0}^{h} {\sum }_{i = 0}^{w} {\vert prev ( x + i , 2 ( y + j ) ) - curr ( x + i , 2 ( y + j ) + 1 ) \vert}^{p}$$

Variances may also be generated for video that may not be interlaced. For a frame picture case, variances may be calculated as follows:

$$BK\_STAD = {\sum }_{x = 0}^{3} {\sum }_{y = 0}^{3} abs ( curr ( x , y ) - prev ( x , y ) )$$

$$BK\_SHCM = {\sum }_{x = 0}^{2} {\sum }_{y = 0}^{3} abs ( curr ( x , y ) - curr ( x + 1 , y ) ) // sum of 12 pixel pairs$$

$$BK\_SVCM = {\sum }_{x = 0}^{3} {\sum }_{y = 0}^{2} abs ( curr ( x , y ) - curr ( x , y + 1 ) ) // sum of 12 pixel pairs$$

Returning to FIG. 3, the encoding of the processed raw video may take place at the encoder at 360, using the variance(s) supplied by the video processor. Reconfiguration of the encoder may take place during the encoding process, leading to the generation of control signals at 370. These control signals may be sent back to the video encoder at 380, to reconfigure the video processor at 390. For example, depending on the variances used by the encoder and the QP value used for encoding, the degree to which certain video processing operations are used may be changed. For example, if the amount of data compression is increased at the encoder, the QP may be larger. Here, it would be desirable to increase the amount of denoising and/or smoothing performed at the video processor. This may he achieved by sending a control signal from the encoder to the video processor, where this control signal would serve to increase the amount of denoising or smoothing. In another example, if there is more motion between frames, it may be desirable for the video processor to perform more blurring. The amount of blurring may be changed at the video processor, based on control signal(s) received from the encoder.

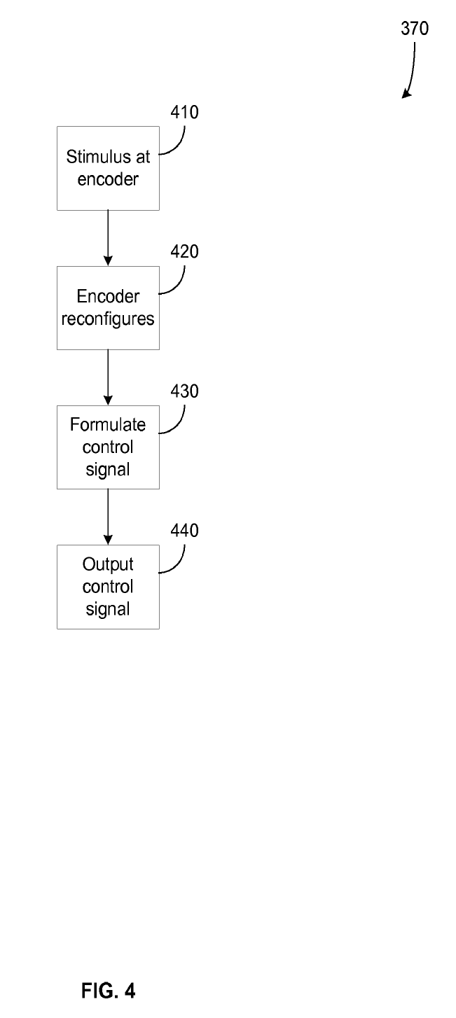

The generation of a control signal (370 in FIG. 3) is illustrated in greater detail in FIG. 4. Here, at 410, a stimulus event may take place at the encoder. An application request may be received, or a bitrate change may take place, for example. As a result, the encoder may reconfigure itself at 420. If the bitrate increases, for example, the encoder may reconfigure itself to increase data compression. At 430, a control signal may be formulated, directing the video processor to alter one or more aspects of its processing in a manner compatible with the reconfiguration of the encoder. At 440, the control signal may be output to the video processor.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, or other data storage device.

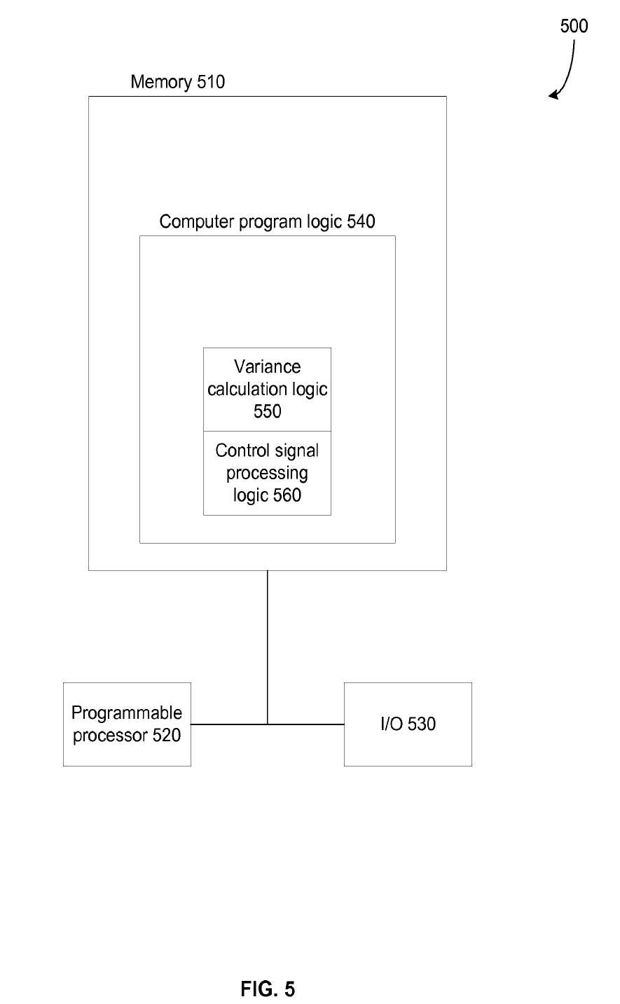

A software embodiment of a video processor 240 is illustrated in FIG. 5, according to an embodiment. The illustrated system 500 may include one or more programmable processor(s) 520 that execute the video processor functionality described above. The system 500 may further include a body of memory 510. Programmable processor(s) 520 may include a central processing unit (CPU) and/or a graphics processing unit (GPU). Memory 510 may include one or more computer readable media that may store computer program logic 540. Memory 510 may be implemented as a hard disk and drive, a removable media such as a compact disk, a read-only memory (ROM) or random access memory (RAM) device, for example, or some combination thereof. Programmable processor(s) 520 and memory 510 may be in communication using any of several technologies known to one of ordinary skill in the art, such as a bus. Computer program logic 540 contained in memory 510 may be read and executed by programmable processor(s) 520. One or more I/O ports and/or I/O devices, shown collectively as I/O 530, may also be connected to processor(s) 520 and memory 510.

In the illustrated embodiment, computer program logic 540 in the video processor may include variance calculation logic 550, which calculated variances such as those identified above. These variances may then be passed to an encoder. Computer program logic 540 may also include control signal processing logic 560, which may be responsible for receiving control signals from the encoder and modifying the operation of the video processor in accordance with such signals.

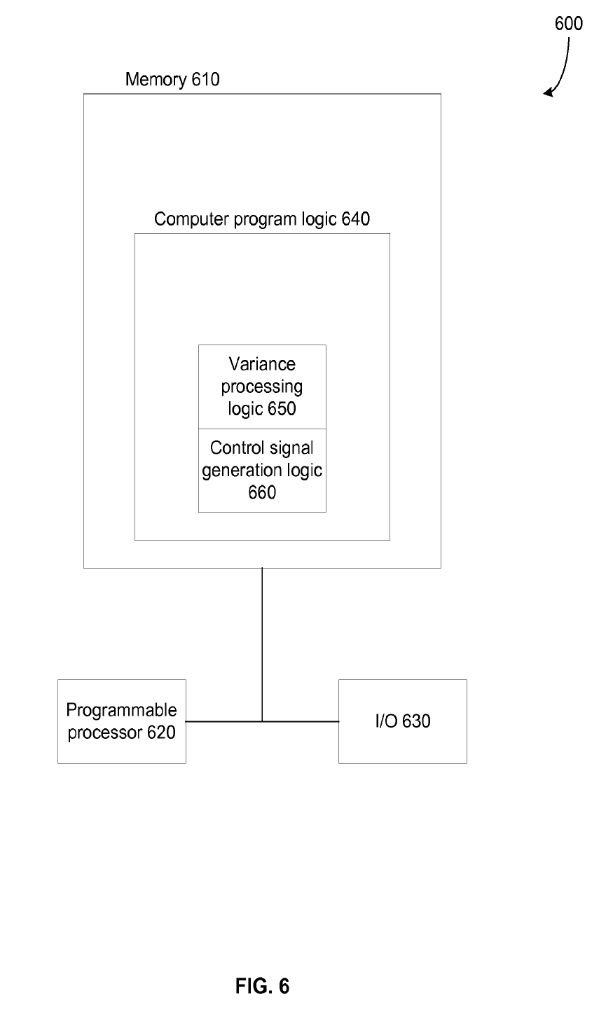

A software embodiment of a encoder 260 is illustrated in FIG. 6, according to an embodiment. The illustrated system 600 may include one or more programmable processor(s) 620 that execute the video processor functionality described above. The system 600 may further include a body of memory 610. Programmable processor(s) 620 may include a central processing unit (CPU) and/or a graphics processing unit (GPU). Memory 610 may include one or more computer readable media that may store computer program logic 640. Memory 610, like memory 510, may be implemented as a hard disk and drive, a removable media such as a compact disk, a read-only memory (ROM) or random access memory (RAM) device, for example, or some combination thereof. Programmable processor(s) 620 and memory 610 may be in communication using any of several technologies known to one of ordinary skill in the art, such as a bus. Computer program logic 640 contained in memory 610 may be read and executed by programmable processor(s) 620. One or more I/O ports and/or I/O devices, shown collectively as I/O 630, may also be connected to processor(s) 620 and memory 610.

in the embodiment of FIG. 6, computer program logic 640 in the video processor may include variance processing logic 650, which receives calculated variances such as those identified above, from the video processor. Logic 650 may then use the variances in the encoding process. Computer program logic 640 may also include control signal generation logic 660, which may be responsible for generating the control signals that may be sent to the video processor.

Note that in other embodiments, there may be a single programmable processor that executes logic corresponding to the above functionality for both the video processor and the encoder.

In one embodiment, systems 500 and 600 may be implemented as part of a wired communication system, a wireless communication system, or a combination of both. In one embodiment, for example, systems 500 and 600 may be implemented in a mobile computing device having wireless capabilities. A mobile computing device may refer to any device having a processing system and a mobile power source or supply, such as one or more batteries, for example.

Examples of a mobile computing device may include a laptop computer, ultra-mobile PC, portable computer, handheld computer, palmtop computer, personal digital assistant (PDA), cellular telephone, combination cellular telephone/PDA, smart phone, pager, one-way pager, two-way pager, messaging device, data communication device, MID, MP3 player, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may he made therein without departing from the spirit and scope of the methods and systems disclosed herein. Thus, the breadth and scope of the claims should not be limited by any of the exemplary embodiments disclosed herein,

What is claimed is:

1. A method, comprising:
at a video processor, processing raw video received from a decoder to produce processed raw video;
calculating variances at the video processor;
sending the processed raw video to an encoder; and
sending the variances to the encoder to facilitate an encoding process.

2. The method of claim 1, wherein said processing of the raw video comprises at least one of deblocking and artifact fixing.

3. The method of claim 1, wherein said processing of the raw video comprises at least one of statistical image analysis and pixel-based image analysis.

4. The method of claim 1, wherein said processing of the raw video comprises at least one of:
deinterlacing;
inverse telecine conversion;
denoising;
color balancing;
frame conversion; and
scaling.

5. The method of claim 1, wherein the raw video comprises interlaced frames, and the variances comprise one or more of:
a variance for a top picture of a previous frame;
a variance for a bottom picture of the previous frame;
a variance for a top picture of a current frame; and
a variance for a bottom picture of a current frame.

6. The method of claim 1, wherein the raw video comprises interlaced frames, and the variances comprise one or more of:
a variance between a top picture of a current frame and a top picture of a previous frame; and
a variance between a bottom picture of the current frame and a bottom picture of the previous frame.

7. The method of claim 1, wherein the raw video comprises interlaced frames, and the variances comprise one or more of:
a variance between a top picture of a previous frame and a bottom picture of the previous frame;
a variance between a top picture of a current frame and a bottom picture of a current frame;
a variance between the top picture of the current frame and the bottom picture of the previous frame; and
a variance between the bottom picture of the current frame and a top picture of the previous frame.

8. The method of claim 1, further comprising:
at the video processor, receiving one or more control signals from the encoder; and
modifying the operation of the video processor on the basis of the control signals.

9. A system, comprising:
a programmable processor in a video processor; and
a memory in communication with said programmable processor, said memory configured to store a plurality of processing instructions for directing said programmable processor to:
process raw video received from a decoder to produce processed raw video;
calculate variances;
send the processed raw video to an encoder; and
send the variances to the encoder to facilitate an encoding process.

10. The system of claim 9, wherein the processing of the raw video comprises at least one of deblocking and artifact fixing.

11. The system of claim 9, wherein the processing of raw video comprises at least one of statistical image analysis and pixel-based image analysis.

12. The system of claim 9, wherein the processing of raw video comprises at least one of:
deinterlacing;
inverse telecine conversion;
denoising;
color balancing;
frame conversion; and
scaling.

13. The system of claim 9, wherein the raw video comprises interlaced frames, and the variances comprise one or more of:
a variance for a top picture of a previous frame;
a variance for a bottom picture of the previous frame;
a variance for a top picture of a current frame; and
a variance for a bottom picture of a current frame.

14. The system of claim 9, wherein the raw video comprises interlaced frames, and the variances comprise one or more of:
a variance between a top picture of a current frame and a top picture of a previous frame; and
a variance between a bottom picture of the current frame and a bottom picture of the previous frame.

15. The system of claim 9, wherein the raw video comprises interlaced frames, and the variances comprise one or more of:
a variance between a top picture of a previous frame and a bottom picture of the previous frame;
a variance between a top picture of a current frame and a bottom picture of a current frame;
a variance between the top picture of the current frame and the bottom picture of the previous frame; and
a variance between the bottom picture of the current frame and a top picture of the previous frame.

16. The system of claim 9, wherein said memory is further configured to store a plurality of processing instructions for directing said programmable processor to:
receive one or more control signals from the encoder; and
modify the operation of the video processor on the basis of the control signals.

17. The system of claim 9, wherein the raw video comprises non-interlaced frames.

18. A computer program product including non-transitory computer readable media having computer program logic stored therein, the computer program logic comprising:
logic to cause a processor to process raw video received from a decoder to produce processed raw video;
logic to cause the processor to calculate one or more variances;
logic to cause the processor to send the processed raw video to an encoder; and
logic to cause the processor to send the variances to the encoder to facilitate an encoding process.

19. The computer program product of claim 18, wherein the processing of the raw video comprises at least one of deblocking and artifact fixing.

20. The computer program product of claim 18, wherein the processing of raw video comprises at least one of statistical image analysis and pixel-based image analysis.

21. The computer program product of claim 18, wherein the processing of raw video comprises at least one of:
deinterlacing;
inverse telecine conversion;
denoising;
color balancing;
frame conversion; and
scaling.

22. The computer program product of claim 18, wherein the raw video comprises interlaced frames, and the variances comprise one or more of:
a variance for a top picture of a previous frame;
a variance for a bottom picture of the previous frame;
a variance for a top picture of a current frame; and
a variance for a bottom picture of a current frame.

23. The computer program product of claim 18, wherein the raw video comprises interlaced frames and the variances comprise one or more of:
a variance between a top picture of a current frame and a top picture of a previous frame; and
a variance between a bottom picture of the current frame and a bottom picture of the previous frame.

24. The computer program product of claim 18, wherein the raw video comprises interlaced frames, and the variances comprise one or more of:
a variance between a top picture of a previous frame and a bottom picture of the previous frame;
a variance between a top picture of a current frame and a bottom picture of a current frame;
a variance between the top picture of the current frame and the bottom picture of the previous frame; and
a variance between the bottom picture of the current frame and a top picture of the previous frame.

25. The computer program product of claim 18, the computer program logic further comprising:
logic to cause the processor to receive one or more control signals from the encoder; and
logic to cause the processor to modify its operation on the basis of the control signals.

26. A system, comprising:
a programmable processor in an encoder; and
a memory in communication with said programmable processor, said memory configured to store a plurality of processing instructions for directing said processor to:
receive one or more variances calculated by a video processor; and
perform encoding of processed raw video from said video processor using said variances.

27. The system of claim 26, wherein said plurality of processing instructions are configured to further direct said processor to:
create control signals configured to instruct said video processor to modify its processing.

28. The system of claim 26, wherein the processed raw video comprises in aced frames, and the variances comprise one or more of:
a variance for a top picture of a previous frame;
a variance for a bottom picture of the previous frame;
a variance for a top picture of a current frame; and
a variance for a bottom picture of a current frame.

29. The system of claim 26, wherein the processed raw video comprises interlaced frames, and the variances comprise one or more of:
a variance between a top picture of a current frame and a top picture of a previous frame; and
a variance between a bottom picture of the current frame and a bottom picture of the previous frame.

30. The system of claim 26, wherein the processed raw video comprises interlaced frames, and the variances comprise one or more of:
a variance between a top picture of a previous frame and a bottom picture of the previous frame;
a variance between a top picture of a current frame and a bottom picture of a current frame;
a variance between the top picture of the current frame and the bottom picture of the previous frame; and
a variance between the bottom picture of the current frame and a top picture of the previous frame.
